(19) United States
(12) Patent Application Publication
(10) Pub. No.: US 2006/0242351 A1
(43) Pub. Date: Oct. 26, 2006

(54) Method and apparatus for loading instructions into high memory

(76) Inventor: Nasrollah A. Kavian, Katy, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/111,180

(22) Filed: Apr. 20, 2005

(51) Int. Cl. G06F 13/36

(52) U.S. Cl. 710/309

(57) ABSTRACT

There is provided a system and method for loading instructions into high memory. Specifically, there is provided a method of operating a computer comprising entering a protected mode before the computer boots a software operating system, and loading instructions stored on an expansion card into a high memory space of the computer, wherein the instructions are loaded after the computer enters the protected mode.

### BACKGROUND

This section is intended to introduce the reader to various aspects of art, which may be related to various aspects of the present invention that are described and claimed below. This discussion is believed to be helpful in providing the reader with background information to facilitate a better understanding of the various aspects of the present invention. Accordingly, it should be understood that these statements are to be read in this light, and not as admissions of prior art.

Modem computers may employ a variety of expansion cards to add functionality to the computer. Examples of these expansion cards include Peripheral Component Interconnect (“PCI”) cards, PCI-X cards, or PCI express cards. These expansion cards may have specific instructions or drivers that when executed initialize the expansion card or facilitate communication between the expansion card and the computer's motherboard or processor. These instructions or drivers are typically stored in a Read-Only Memory (“ROM”) device, known as an option ROM, which is located on the expansion card. The computer may copy the instructions or drivers from the option ROM to the computer's main memory and then execute instructions or drivers to initialize the expansion card.

Intel 80×86-based processors have two primary operating modes: real mode and protected mode. 80×86-based processors are initially in the real mode after a power-up or restart. In the real mode, the processor uses 20 bit memory addresses to access the computer's Random Access Memory (“RAM”). These 20 bit addresses correlate to one megabyte of storage (i.e., 2²⁰ bits). For this reason, 80×86-based processors operating in real mode are only able to access the first one megabyte of the computer's RAM. When operating in protected mode, however, the processor uses longer, more complex memory addresses and the processor is thus able to access all or virtually all of the computer's RAM (including the one megabyte accessible during real mode operation). In conventional computer systems, the computer's software operating system executes additional instructions during the operating system's boot process to enter the protected mode. Traditionally, expansion cards are initialized while the computer is operating in the real mode. Because of the limited amount of RAM available in the real mode, option ROM initialization instructions and drivers have traditionally been quite small in size (e.g., 64 kilobytes).

### BRIEF DESCRIPTION OF THE DRAWINGS

FIG. 1 is a block diagram illustrating an exemplary computer system configured to load instructions into high memory in accordance with an exemplary embodiment of the present invention;

FIG. 2 is a flow chart illustrating an exemplary process flow for loading instructions into high memory in accordance with an exemplary embodiment of the present invention; and

FIG. 3 is a block diagram illustrating an exemplary memory map in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed toward a method or a system for enabling the instructions stored on an option ROM to be loaded into the high memory area of the computer's main memory. Specifically, in one embodiment, a computer system may enter protected mode prior to loading the instructions and drivers stored in the option ROMs. In this way, the option ROM's instructions or drivers may be loaded into either the low memory or the high memory.

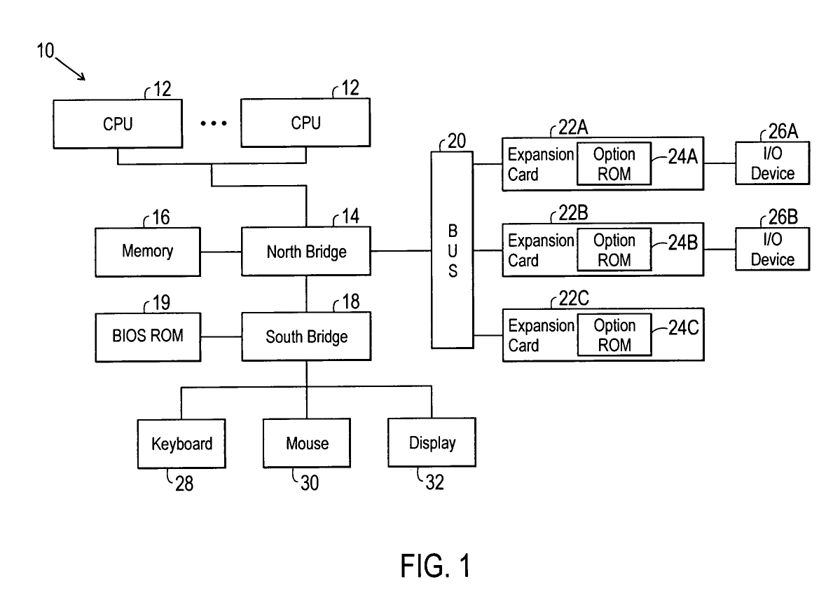

Turning now to FIG. 1, a block diagram of an exemplary computer system configured to load instructions into high memory in accordance with an exemplary embodiment is illustrated and generally designated by a reference numeral 10. The computer system 10 may include one or more processors or central processing units (“CPUs”) 12. While the CPU 12 will be referred to primarily in the singular, it will be understood by one of ordinary skill in the art that a computer system 10 with any number of physical or logical CPUs 12 may be implemented. Examples of suitable CPUs 12 include the Intel Pentium 4 Processor and the AMD Athlon Processor.

The CPU 12 may be operatively coupled to a north bridge 14, such as an Intel 82451NX Memory and I/O Bridge Controller (MIOC). The north bridge 14 may include a memory controller for accessing a main memory 16 (e.g., dynamic random access memory (“DRAM”)), and a peripheral component interconnect (“PCI”) controller for interacting with an expansion bus 20. Thus, the north bridge 14 provides the data port and buffering for data transferred between the CPU 12, the memory 16, and the expansion bus 20.

The north bridge 14 may also be coupled to a south bridge 18. The south bridge 18 is an integrated multifunctional component, such as the Intel 82371 (a.k.a. PIIX4), that includes a number of functions, such as, an enhanced direct memory access (“DMA”) controller; interrupt controller; timer; integrated drive electronics (“IDE”) controller for providing an IDE bus (not shown); a universal serial bus (“USB”) host controller for providing a universal serial bus (not shown); and an industry standard architecture (“ISA”) bus controller for providing an ISA bus (not shown). The south bridge may also be coupled to a Basic Input/Output System (“BIOS”) ROM 19 and to a variety of suitable human input or output devices, such as a keyboard 28, a mouse 30, or a display 32. One of ordinary skill in the art, however, will appreciate that the routing of signals through the computer system 10 can be readily adjusted in alternate embodiments. For example, the south bridge 18 may be coupled directly to the CPU 12.

As stated above, the north bridge 14 may also be coupled to the expansion bus 20. The expansion bus 20 may permit the addition of expansion cards into the computer system 10. The expansion bus 20 may comprise a Peripheral Component Interconnect (“PCI”) bus, a PCI-X bus, or a PCI express bus. One of ordinary skill in the art will appreciate that other types of suitable expansion bus technologies may be employed as well.

The expansion bus 20 may be coupled to one or more expansion cards 22a, 22b, and 22c. The expansion cards 22a, 22b, and 22c may add functionality to the computer system 10. For example, the expansion cards 22a, 22b, and 22c may perform an input/output (“I/O”) function for the computer system 10. In one embodiment, the expansion cards 22a, 22b, and 22c may comprise a disk drive controller, such as a Redundant Array of Inexpensive Disks (“RAID”) controller. In alternate embodiments, the expansion cards 22a, 22b, and 22c may couple the computer system 10 to another computer system or to the Internet. One of ordinary skill in the art will appreciate that the above-listed examples are exemplary.

The expansion cards 22a, 22b, and 22c may comprise PCI cards, PCI express cards, or PCI-X cards. The expansion cards 22a, 22b, and 22c may be coupled to one or more input/output (“I/O”) devices 26a and 26b. In one embodiment, the I/O devices 26a and 26b may comprise a plurality of storage devices, such as a RAID. In alternate embodiments, the I/O devices 26a and 26b may comprise a variety of other suitable peripheral devices.

Each of the expansion cards 22a, 22b, and 22c may comprise the option ROMs 24a, 24b, and 24c, respectively. The option ROMs 24a, 24b, and 24c may be comprised of any suitable form of non-volatile memory device. The option ROMs 24a, 24b, and 24c may be configured to store instructions and/or drivers to initialize or operate the expansion cards 22a, 22b, and 22c or the I/O devices 26a, 26b. In one embodiment, the instructions stored in the option ROM 24a, b, or c may comprise a utility program associated with one of the respective I/O devices 26a and 26b.

It is important to note that the computer system 10 described above in relation to FIG. 1 is merely one example of the system configured to load instructions into high memory. The functions described above may alternatively be implemented in separate integrated circuits or combined differently than described above.

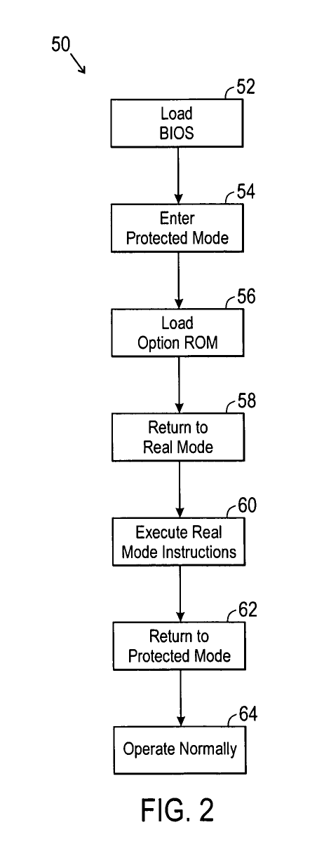

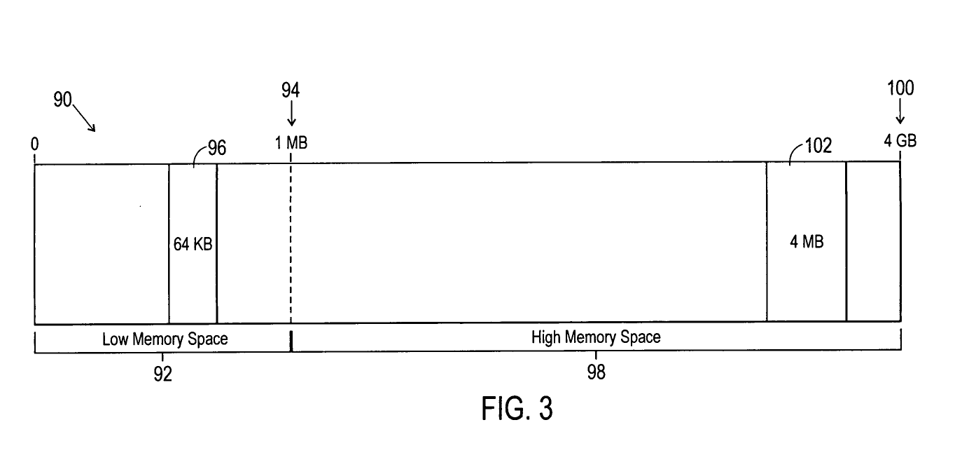

Turning next to FIG. 2, a diagram of an exemplary process flow for loading instructions into high memory in accordance with an exemplary embodiment is illustrated and generally designated by a reference numeral 50. As illustrated in block 52, the computer system 10 loads the BIOS from ROM to RAM. Specifically, loading the BIOS may comprise copying instructions from the BIOS ROM 19 into a low memory space 92 of the memory 16 (see FIG. 3). As used herein, the low memory space 92 comprises the one megabyte of memory accessible by the CPU 12 when the CPU 12 is operating in real mode. Once the instructions from the BIOS ROM 19 have been copied to the memory 16, the CPU 12 may execute the BIOS instruction to initialize and configure the chipset 14.

After the BIOS has been loaded, the computer system 10 loads video support from ROM to RAM. Typically, loading video support comprises loading initialization instructions from a video ROM (not shown) located in the computer system 10 into the low memory space 92 and then executing those instructions. In alternate embodiments, however, the computer system 10 may load video support by loading instructions and/or drivers from one of the option ROMs 24a, 24b, and 24c, as will be described in relation to block 56.

After the video support software has been loaded, the process 50 may continue with the computer system 10 entering a protected mode, as indicated in block 54. In one embodiment, entering the protected mode comprises executing instructions to enable high memory access, set up an interrupt table, and set up a global descriptor table. These instructions may be stored either in the BIOS ROM 19, in one of the option ROMs 24a, 24b, and 24c, or elsewhere in the computer system 10. Instructions to enable high memory, set up an interrupt table, and set up a global descriptor table are well known in the art and need not be described in detail.

After the computer system 10 has entered the protected mode, the process 50 may continue by loading the instructions stored in the option ROMs 24a, 24b, and 24c, into the memory 16, as indicated in block 56. Because the computer system 10 is in protected mode, the computer system 10 is able to load the instructions stored on the option ROMs 24a, 24b, and 24c a high memory 98 (see FIG. 3) in addition to the low memory 92. For example, the computer system 10 may copy a four megabyte initialization and utility program from the option ROM 24a, 24b, and 24c to the high memory 98 of the memory 16. As used herein, the high memory space 98 comprises the memory 16 that is not a part of the low memory space 92. FIG. 3 illustrates one example of the memory 16 between the low memory 92 and high memory 98.

FIG. 3 is a diagram illustrating an exemplary memory map 90 in accordance with an exemplary embodiment. One of ordinary skill in the art will appreciate that FIG. 3 is illustrative only and is not depicted to scale. In one embodiment, the memory 90 may represent a map of the memory 16 depicted in FIG. 1. As described earlier, the memory 16 (as represented by the memory map 90) may comprise the low memory space 92 and the high memory space 98. The low memory space 92 includes the memory up to a one megabyte boundary 94. The high memory space 98 comprises the memory from the one megabyte memory boundary 94 up to the remainder of the system memory. The memory map 90, depicted in FIG. 3, is illustrated with four gigabytes of system memory (reference numeral 100). In alternate embodiments, the amount of storage in the memory 16 may be higher or lower depending on the configuration of the computer system 10.

As described above, instructions and/or drivers from the option ROMs 24a, 24b, and 24c may be loaded into the high memory space 98. For example, the four megabyte initialization and utilization program described earlier can be loaded into a four megabyte block of memory 102. Once the instructions have been copied into the high memory space 98 of the memory 16, the instructions from the option ROM 24a, 24b, and 24c (now stored in the memory 16) may be executed by the CPU 12. These instructions, when executed, may initialize the expansion card 22a, initialize the I/O device 26a, or initialize a disk drive storage controller and an array of hard drives (e.g., a RAID). In an alternate embodiment, the instructions from the option ROM 24a, 24, and 24c may be executed at a later point. For example, the instructions from the option ROM 24a, 24b, and 24c may be executed after an operating system has been loaded.

Returning back to FIG. 2, once the instructions from option ROMs 24a, 24b, and 24c have been loaded into the memory 16 the process 50 may continue by returning to real mode, as indicted in block 58. In one embodiment, returning to the real mode may comprise deinitializing the global descriptor table and deinitializing the interrupt table. It is important to note, however, that in one embodiment, the instructions loaded from the option ROMs 24a, 24b, and 24c into the high memory space 98 will remain present in the high memory space 98 after the computer system 10 exits the protected mode. As such, the instructions stored in the high memory space 98 may be accessed even after the computer system 10 has loaded an operating system and is operating normally (see block 64). In one embodiment, the instructions remain accessible if the expansion card 22a, 22b, and 22c marks the memory range in the high memory space 98 as being reserved by the expansion card 22a, 22b, and 22c.

One of ordinary skill in the art will appreciate that the process 50 can load instructions, such as a utility program, into the high memory space 98 of the computer system 10 without, and independent of, an operating system, because the instructions are loaded into the high memory space 98 before the computer system 10 loads the operating system. This feature is particularly advantageous because it may allow uniform support or technical assistance regardless of the operating system that is employed by the computer system 10. For example, the manufacturer of the I/O device 26a and 26b may include a diagnostic program for the I/O device 26a and 26b on the option ROM 24a and 24b. Because this diagnostic program is loaded into the high memory 98 before the operating system, neither its location in the memory nor its operation is dependent on the operating system. Thus, a technical support specialist can be assured of consistent operation of the diagnostic program regardless of what type of operating system is selected by the user.

After the computer system 10 has returned to the real mode, the process 50 may continue by executing a real mode instructions, such as executing an operating system boot process, as indicated in block 60. Executing the operating system boot process is well known to one of ordinary skill in the art and need not be described in detail. Typically the boot process will comprise returning to the protected mode, as illustrated in block 62. It will be understood, however, that reentering the protected mode should not affect the instructions loaded from the option ROMs 24a, 24b, and 24c. After the operating system has re-entered the protected mode, the computer system will operate normally, as indicated by block 64.

Many of the steps of the exemplary process described above with reference to FIG. 2 comprise an ordered listing of executable instructions for implementing logical functions. The ordered listing can be embodied in a computer-readable medium for use by or in connection with a computer-based system that can retrieve the instructions and execute them to carry out the previously described processes. In the context of this application, the computer-readable medium can be a means that can contain, store, communicate, propagate, transmit or transport the instructions. By way of example, the computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette, a random access memory (RAM) a read-only memory (ROM), an erasable programmable read-only memory (EPROM or Flash memory), an optical fiber, and a portable compact disk read-only memory (CDROM). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed:

1. A method of operating a computer comprising:
entering a protected mode before the computer boots a software operating system; and
loading instructions stored on an expansion card into a high memory space of the computer, wherein the instructions are loaded after the computer enters the protected mode.

2. The method, as set forth in claim 1, wherein loading the instructions comprises loading instructions stored in a Read Only Memory (ROM) located on the expansion card.

3. The method, as set forth in claim 1, wherein loading the instructions comprises loading instructions stored on an option ROM.

4. The method, as set forth in claim 1, wherein entering the protected mode comprises:
enabling high memory;
setting up an interrupt table; and
setting up a global descriptor table.

5. The method, as set forth in claim 1, further comprising exiting the protected mode after loading the instructions.

6. The method, as set forth in claim 1, wherein the instructions comprise an initialization routine.

7. The method, as set forth in claim 1, wherein the instructions comprise software configured to be executed after the operating system is loaded.

8. A computer comprising:
a memory configured into a low memory space and a high memory space;
a processor configured to execute instructions loaded into the memory; and
an expansion card communicatively coupled to the memory and the processor, wherein the computer is configured to:
enter a protected mode; and
load instructions stored on the expansion card into the high memory space, wherein the instructions are loaded after the computer enters the protected mode.

9. The computer, as set forth in claim 8, wherein the instructions are stored in a Read Only Memory located on the expansion card.

10. The computer, as set forth in claim 8, wherein the instructions are stored in an option ROM located on the expansion card.

11. The computer, as set forth in claim 8, further comprising an input output (I/O) device coupled to the expansion card.

12. The computer, as set forth in claim 8, wherein the I/O device comprises Redundant Array of Inexpensive Disks (RAID) and wherein the expansion card comprises a RAID controller.

13. The computer, as set forth in claim 8, wherein the computer is configured to exit the protected mode after loading the instructions.

14. A tangible machine readable medium comprising:
code adapted to enter a protected mode before a computer boots a software operating system; and
code adapted to load instructions stored on an expansion card into a high memory space of the computer, wherein the instructions are loaded after the computer enters the protected mode.

15. The tangible medium, as set forth in claim 14, wherein the instructions are stored in an option ROM located on the expansion card.

16. A computer system comprising a utility program, wherein the utility program was copied into a high memory space of the computer system's memory from an option ROM prior to the execution of a software operating system.

17. The computer system, as set forth in claim 16, wherein the utility program is configured to be executed after the execution of the operating system.

18. The computer system, as set forth in claim 16, wherein the utility program is adapted to be operating system independent.

19. A method comprising:
copying instructions from a BIOS ROM to the system memory;
entering a protected mode, wherein the protected mode is entered before an software operating system is loaded;
copying instructions from an option ROM to the system memory;
returning to real mode;
executing real mode instructions to boot the software operating system; and
reentering the protected mode.

20. The method, as set forth in claim 19, wherein entering the protected mode comprises:
enabling high memory;
setting up an interrupt table; and
setting up a global descriptor table.
